(19) United States
(12) Patent Application Publication
(10) Pub. No.: US 2006/0168201 A1
(43) Pub. Date: Jul. 27, 2006

(54) Safeguarded integrated means for internet-based CM systems

(75) Inventor: Roland Schuhle, Ravensburg (DE)

Correspondence Address: ROBERTS, MLOTKOWSKI & HOBBES, P. O. BOX 10064, MCLEAN, VA, 22102-8064, US

(73) Assignee: Prueftechnik Dieter Busch AG, Ismaning (DE)

(21) Appl. No.: 11/266,590

(22) Filed: Nov. 4, 2005

(30) Foreign Application Priority Data
Nov. 4, 2004 (DE) 10 2004 053.818.2
Nov. 5, 2004 (DE) 10 2004 054 050.0
Nov. 22, 2004 (DE) 10 2004 056 237.7

(51) Int. Cl. G06F 15/16; G06F 15/173

(52) U.S. Cl. 709/224; 709/206

(57) ABSTRACT

An overall condition monitoring (CM) system with at least one CM center (60) and the respective CM systems (50, 52), which can be located anywhere, together with the associated LAN and/or Internet-data network structures is designed such that protocol-blocking logic or physical devices (PB5, PB6, PB8) monitor the data traffic and ensure that essentially only e-mail data traffic occurs in data transfer out of the jurisdiction of the Internet to the CM system (50, 60) after intensive and extensive checking the data for malevolent content.

### BACKGROUND OF THE INVENTION

1. Field of Invention

This invention relates to an integrated means and a corresponding process for transmission of information using the Internet and its logical and physical components. In particular, the invention relates to a process for obtaining especially high reliability, availability, and protection for data transmission for condition monitoring (CM systems) including their sensors and associated actuators, within an integrated arrangement of higher-order and lower-order computers. This integrated arrangement can have a very decentralized structure, with many satellite arrangements.

2. Description of Related Art

The problem to be solved has fewer technical than psychological causes since, in the past, in the Internet, there has unfortunately been an enormous increase in the sending of malevolent software in the form of viruses and the like. Furthermore, an increase in this phenomenon cannot be precluded. Various types of software for blocking and/or removing viruses, spyware, adware and other unwanted software-based agents exist, but none are totally effective and failure to continually update such software can render it useless to due to the constantly evolving nature of malevolent software as their producers adapt to the mechanisms seeking to block there efforts. Thus, a more effect means for solving this problem is needed.

### SUMMARY OF THE INVENTION

This problem is solved by the invention in that an overall condition monitoring (CM) system, with at least one CM center and the pertinent CM systems located anywhere and the pertinent LAN and/or Internet-data network structures, is provided in which protocol-blocking logic or physical devices monitor and safeguard the data traffic, that in data transfer from the jurisdiction of the Internet in the direction of a CM system essentially only (and in one preferred configuration of the invention solely and exclusively) e-mail data traffic can occur.

According to the invention, this integrated means is implemented in that, of the data transfer paths allowed in the Internet, such as, for example, the File Transfer Protocol (FTP), HTTP, UDP and SMTP (e-mail transfer) or others, also highly advantageously, preferably exclusively, e-mail transfer for sending, and especially for receiving, data by CM systems is allowed. On the other hand, it is allowed in accordance with the invention that within a controlled and monitored LAN (Local Area Network) all conceivable data transmission protocols to and from a CM system are allowed.

The advantages of this specific limitation of Internet use consists in that data which develop a malevolent programming effect, especially a reprogramming effect, can be more easily and specifically kept away from networked CM system and their sensors or actuators. These malevolent data can be contained, for example, in Java applets, active X elements, and macros for software products, such a Microsoft Windows or Microsoft Excel. However, of course, it can also be a matter of regular computer viruses, so-called Trojan horses, so-called spyware, and other unwanted software-based agents. In this respect, the invention provides for desired and legitimate data exchange between a CM center located anywhere around the world and CM systems which can likewise be placed almost anywhere to use the Internet infrastructure, but for its use as a data transfer medium, allowing only communication via e-mail servers or comparable components and by way of the pertinent protocols like SMTP. Any other communication protocols which are allowed by the Internet or are present there are blocked in conjunction with the essentially autonomously operating CM systems, for the purposes of this invention, or allowed if need be at the client's wish. Regardless, outside of the jurisdiction of the Internet, all other possible physical and logical data transmission mechanisms and protocols for data transfer of an overall CM system can be allowed.

In particular, it is the subject of the invention to devise reliable and easily available data transfer for purposes of reconfiguration of only occasionally supervised CM systems. This is achieved in that, especially, the sending of data for purposes of transmission of commands, parameters, program parts or entire programs (for example, so-called upgrades), therefore also so-called updates, is done to great advantage only over e-mail data channels. In one special and restrictive embodiment of the invention, the aim is to send data solely and exclusively over e-mail data channels, for example, according to the SMTP protocol.

### DETAILED DESCRIPTION OF THE INVENTION

One example for possible application of the process of the invention is a CM application on offshore wind power plants off several European coasts, with current individual parameters, such as local wind strength, air temperature, currently generated power, efficiency, absence of faults, etc., which can be interrogated worldwide using the Internet, and with settings such as the tilt angle of the vanes, etc. which could be modified, in principle, by any authorized control station of the respective CM system, and with internal programs which are to be implemented for these purposes authorized from a remote location. It goes without saying that, for purposes of proper authorization, special measures must be taken and that, accordingly, any attempt at unauthorized remote influence on the individual CM systems and machinery should remain essentially unsuccessful.

More recent development of Internet technology and diverse malevolent attacks on hardware and software components of trusting Internet users, according to the invention, no longer easily allow all available possibilities of data exchange via the Internet to be permitted for the actions to be taken here. The limitation of this data exchange simply to e-mail data traffic, for example, according to the SMTP, and in this connection, optionally, also only with the additional limitations to be applied here, offers additional security here. In particular, the invention better ensures that a desired reprogramming possibility in the environment of the individual participating CM system will become very difficult for unauthorized individuals and attackers.

The invention is explained in further detail below with reference to the accompanying drawings.

### BRIEF DESCRIPTION OF THE DRAWINGS

FIG. 1 is a schematic representation of a first embodiment of the invention;

FIG. 2 is a representation of an example of the detailed function of a coupling point of the FIG. 1 embodiment;

FIGS. 3 & 4 show a second preferred embodiment of the invention; and

FIG. 5 is a representation for use in explaining the differences between the second preferred embodiment FIGS. 3 & 4 and the prior art.

### DETAILED DESCRIPTION OF THE INVENTION

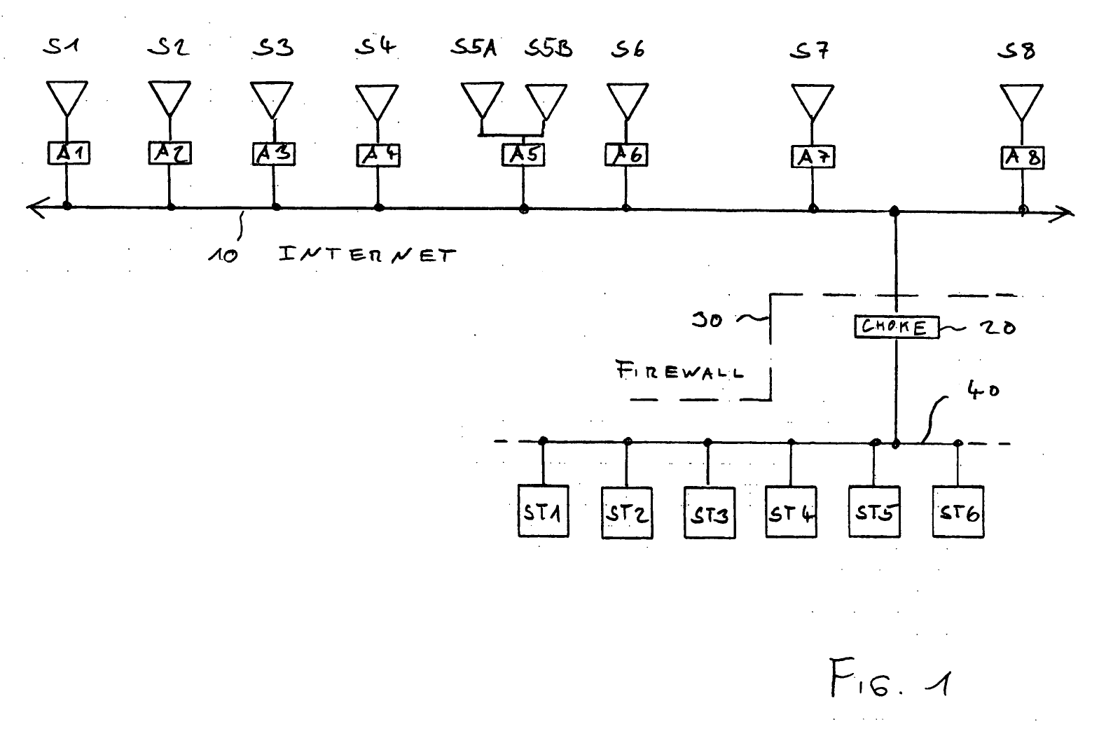

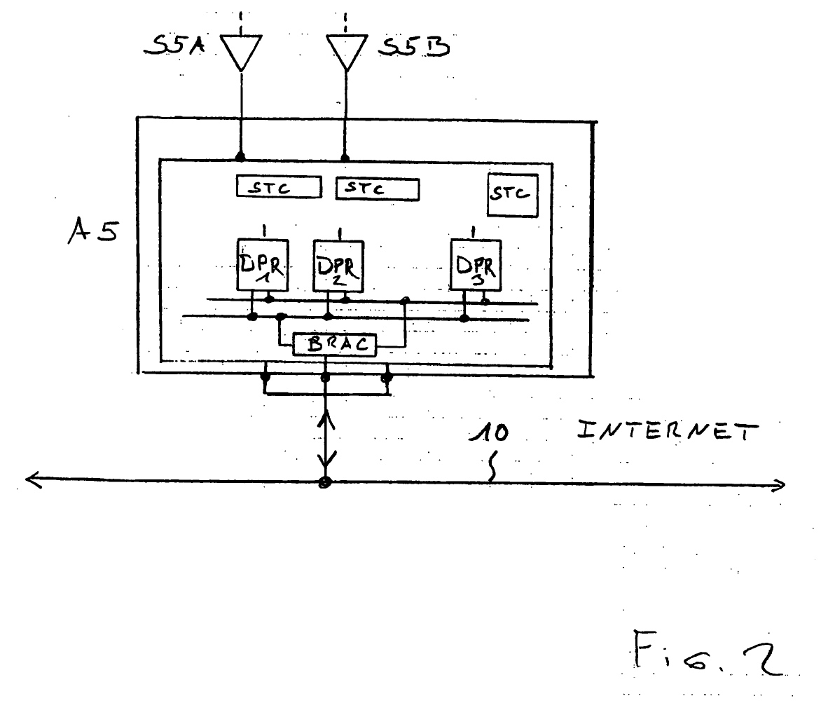

In the first embodiment of the invention shown in FIG. 1, there is a number of sensors (or actuators) S1, S2, S3, . . . locally or worldwide at any locations of interest. The sensors are to be called and interrogated by means of suitable remote interrogation means. It is to be possible to actuate the actuators in a comparable manner. To do this, the hardware and the infrastructure of the Internet 10 are used. In this way, at least one computer, for example, ST1, but preferably, any number of computers which can, in principle, be placed anywhere, can be brought into a dynamic information connection (“online connection”) with these sensors or actuators over the Internet. To do this, it is necessary, in the conventional manner, for the sensors to be able to connect to the Internet by way of suitable coupling points A1 . . . A8 . . . etc., whether over a land line or wirelessly. If necessary, an individual coupling point can also be responsible for several sensors, for example, the coupling point A5 with sensors/actuators S5A and S5B. As regular end points on the Internet, the coupling points A1 . . . are able both to send and also receive data according to a protocol, for example, from a local computer constellation ST1 . . . ST6 which is shown in the bottom part of FIG. 1, which can be locally interconnected over an intranet 40 and which is connected to the Internet by way of suitable servers, filters and security structures, such as a so-called firewall 30 or a so-called choke 20. However, essentially any other suitable regular end point of the Internet (not detailed in FIG. 1) can also quite regularly try to set up a logic-information connection to one of the coupling points A1, etc. However, for reasons of security, it is now allowed in accordance with the invention only that the logic-information connection is set up and made available such that the coupling points A1, etc., in the maximum case, have the operating scopes of e-mails, and thus, are simply able to send or receive information in the scope of e-mails according to worldwide standards, i.e., preferably SMTP. In any case, these operating scopes also include the ability to check the e-mails which are to be sent and also received for viruses and other malevolent software components. If necessary, so-called attachments to the e-mails for data transfer are blocked or relayed to a control authority. These attachments can contain specifically software viruses or logic components with malevolent software properties which cannot be immediately or easily detected.

There are diverse possibilities for providing Internet connectivity which is better safeguarded in the inventive manner between an operator station, for example, ST1 and a remotely mounted sensor (actuator) S8 with additional protective capabilities.

FIG. 2 shows details of one example of the internal functioning of the coupling point A5. The coupling point is equipped, in the conventional manner, with suitable standard computer components STC which need not be explained in detail here since they are known to one skilled in the art. Otherwise, the coupling point is able to accept the signals from the sensors S5A and S5B and send them as a digital signal over the Internet, whether in a preprogrammed, independent manner, or after a request by a legitimate sender with an arranged e-mail text or code.

However, instead of standard memory modules for the internal controller of the coupling point A5, dual port RAMS or ROMS are used. In conjunction with these special memory modules, each coupling point then obtains at least two separate e-mail addresses. One of these e-mail addresses remains confidential and is known on a priority basis only to the legitimate operator of a system which can be set or interrogated by remote action hardware. Depending on the selected e-mail address of the coupling point A5, using a BRAC separating filter, the result is that the memory modules DPR1 . . . DPR3 are available either in a first, noncritical write/read state (for normal operation), or in a second, sensitive write/read state in which a significant part or essentially all the remaining functionality of the coupling module can be reprogrammed, as can be desired by the legitimate owner of this system from case to case. Instead of using dual port memory modules, an equivalent structure with separated memory areas can be used. It goes without saying that, according to the choice of the coupling point in the indicated second operating mode, additional authenticity checks are unconditionally run depending on absolutely secret algorithms. In this way, for random and erroneous selection of such a coupling point in its second operating mode, it is not immediately possible to reprogram parts or the complete internal memory DPR1 . . . DPR3.

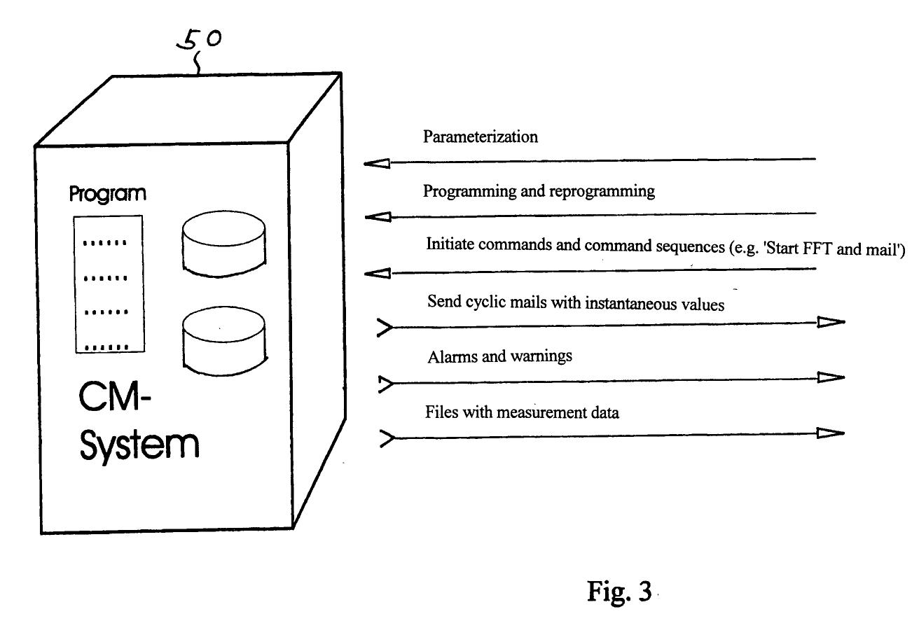

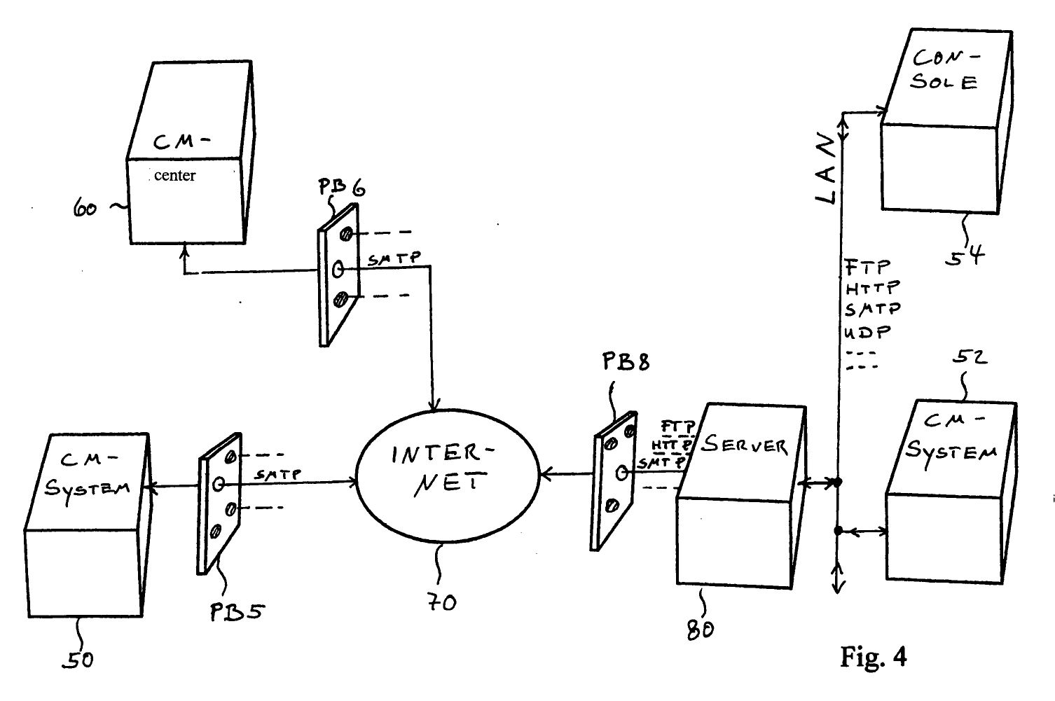

A second, preferred configuration of the invention is shown in FIGS. 3-5.

Instead of individual sensors and the respective coupling points, there are complete CM systems 50 which can likewise detect comparable functions and, moreover, can have additional operating scopes in the sense of independent computer systems. The CM systems 50, typically, have their own executable program structures, extensive storage possibilities (optionally, also bulk storage, such as flash memory, hard disks, and the like). As shown in FIG. 3, the data acting on this CM system 50 can be used, for example, for parameterization of the sensors connected to it, or even for parameterization, for example, with respect to an adjustable performance scope of the system 50 itself. In particular, such a CM system 50 can be programmed or reprogrammed from afar. By special data streams and commands which are directed at such a CM system 50, specific sequences can be initiated. One example would be to sense not only physical quantities and to send them as a data stream to a CM center, but to apply one or more integral transforms to the sensed data on site and to send the corresponding result to the CM center. Moreover, this CM system is typically able to generate, for example, alarms and warnings depending on the external conditions which occur, or to deliver complete files with sets of collected measurement data (also in the case of an interrogation station other than the center), or according to a pre-definable and also reprogrammable roster, to send the currently registered data to predefined users. Here, Internet use is optional, i.e., fundamentally possible, but not necessarily stipulated.

The pertinent overall structure is shown schematically in FIG. 4. Diverse CM systems, of which for example two are identified in the figures with reference numbers 50, 52, can be interconnected with one (or more) CM center(s) 60 into an overall CM system. To do this, the use of the Internet structure 70 with its hardware capabilities is allowed. As in the aforementioned exemplary embodiment, however in this case, only the SMTP protocol or a directly comparable one is also allowed, so that essentially, or preferably solely, the transfer of e-mail based data is possible. Subsystems with the function of protocol blocking PB5, PB6, PB8, etc. are designed for this purpose; they essentially deliver only these data streams to the Internet, and in the opposite direction, allow only these data streams to pass out of the Internet in the direction of the CM system or a CM center when they can be identified as e-mails or are in conformity with the SMTP protocol. For all other protocols, these subsystems PB5, PB6, etc. act normally as logic barriers.

However, as is shown on the right side of FIG. 4, it is possible within a controlled network environment, for example, on a LAN (local area network) within a factory, for other, faster protocols or those which check less for data transfer from and to the CM systems connected there (for example, reference number 52 and others which are not shown) to be allowed. In this respect, these subsystems can also be equipped with their own operating and monitoring consoles 54 which can act independently of the CM center 60, whether fully automatically or according to the intentions of the operator.

CM systems which are set up fully autonomously and in an inaccessible environment, for example 50, can be equipped with additional security mechanisms, as indicated in the first embodiment. In this way, malevolent connections from and to an attacking command source are essentially excluded from the Internet.

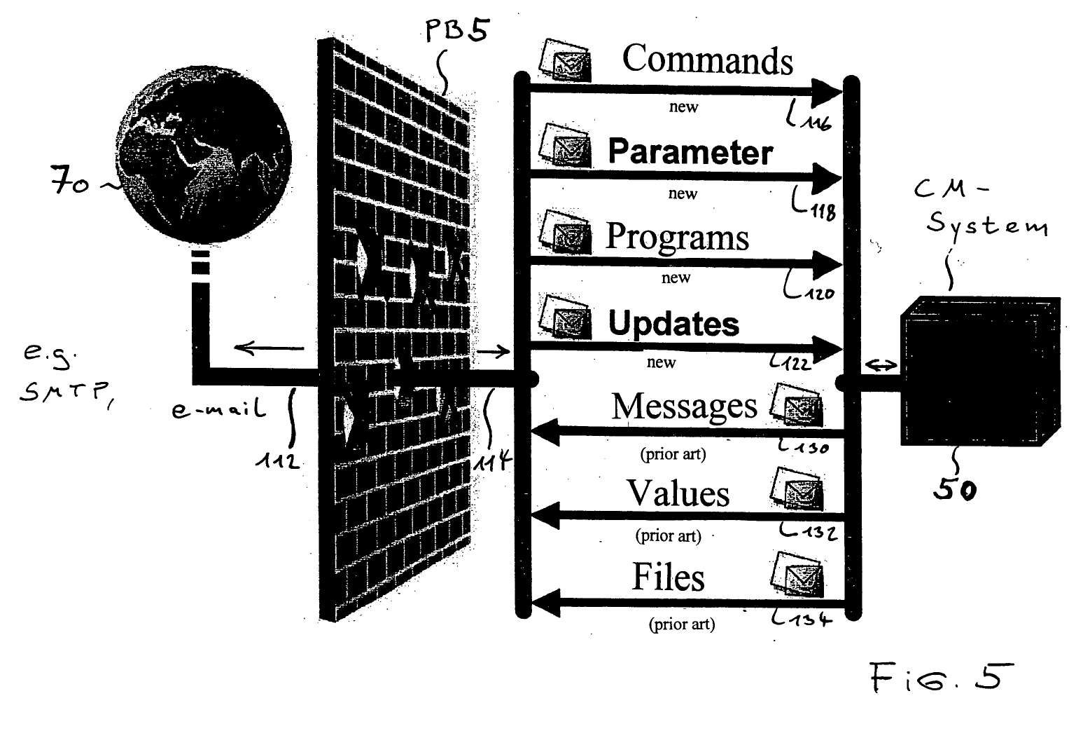

The essence of the second embodiment and the difference from the prior art are shown in FIG. 5. As described above, a CM system (reference number 50) can send data to any recipients on the Internet 70. These data can be, for example, autonomously generated messages (reference number 130), or measured values (132) or also files (134). This can occur for example, over an e-mail data channel (112); this corresponds to the prior art. Conversely, the new approach of the invention is that, at this point, diverse, especially sensitive data streams can and should be directed to a CM system 50 over an e-mail data channel (114), and thus, in an essentially better safeguarded manner than was possible in the past. In this respect, the use of the software protective mechanisms assigned to the means PB5, such as intensively checking virus scanners or the like, is also provided. In particular, sensitive data streams are defined as commands (116), parameters (118), programs or upgrades (120) and updates (122) which are directed to a CM system 50, and consequently, the CM system has an altered functional scope or a modified functionality. Blocking of other protocols is represented by the “X” over each of the other openings in the wall used to depict PB5.

What is claimed is:

1. Process for interrogation or actuation of sensors or actuators which are connectable to the Internet, using remote action hardware, comprising undertaking data transfer from and to the sensors or actuators solely by hardware and software means which are adapted for transmission of e-mail data.

2. Integrated system for Internet-based sensors or actuators and corresponding data processing systems comprising a hardware and software structure which allows simply and exclusively e-mail based data traffic by SMPT between the sensors or actuators and the corresponding data processing systems.

3. Integrated means as claimed in claim 2, in which the Internet-based sensors or actuators are adapted for interrogation or connection over a special coupling point, the special coupling point being equipped with a first and at least one other e-mail address and having internal electronic arrangements and structures by means of which a noncritical operating state in which programming is precluded is implemented when a coupling point is selected by way of the first e-mail address, and a sensitive operating state with a programming possibility is implemented when a coupling point is selected by way of said at least one other e-mail address.

4. Overall condition monitoring system, comprising:
at least one condition monitoring center and respective condition monitoring systems located anywhere and at least one of associated LAN and Internet-data network structures, and
protocol-blocking logic or physical devices which enable e-mail data traffic and data transfer into the jurisdiction of the Internet; and which only accept data from the Internet which can be identified as e-mails or can be assigned to the SMTP protocol.

5. Overall condition monitoring, comprising:
at least one condition monitoring center and respective condition monitoring systems located anywhere and at least one of associated LAN and Internet-data network structures, and
protocol-blocking logic or physical devices which selectively enable either only e-mail data traffic occurring in data transfer from the jurisdiction of the Internet in the direction of the condition monitoring system or alternatively, data transfer from the jurisdiction of the Internet in the direction of the condition monitoring system using FTP, HTTP and other protocols in addition to only e-mail data traffic.

6. Overall condition monitoring system, comprising:
at least one condition monitoring center with at least one CM center (and respective condition monitoring systems located anywhere and at least one of associated LAN and Internet-data network structures, and
protocol-blocking logic or physical devices adapted to monitor data traffic and ensure that solely and exclusively e-mail data traffic can occur in data transfer from the jurisdiction of the Internet to the CM system.

7. Overall condition monitoring system as claimed in claim 6, in which the protocol-blocking devices comprise means for executing a variety of checking, scanning and testing processes against malevolent software.
